(19) United States
(12) Patent Application Publication
(10) Pub. No.: US 2010/0079543 A1
(43) Pub. Date: Apr. 1, 2010

(54) LIQUID EJECTING APPARATUS

(75) Inventor: Kenji OTOKITA, Yamagata-mura (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/568,150

(22) Filed: Sep. 28, 2009

(30) Foreign Application Priority Data
Sep. 29, 2008 (JP) 2008-249907

(51) Int. Cl. B41J 2/145

(52) U.S. Cl. 347/40

(57) ABSTRACT

A liquid ejecting apparatus includes: a liquid ejecting head that ejects liquid from nozzles; a first nozzle group that is formed of nozzles for ejecting the liquid; and a second nozzle group that is disposed on both sides of the first nozzle group in a nozzle arrangement direction, and is formed of nozzles for ejecting liquid droplets having the same characteristics as liquid droplets of the first nozzle group and ejecting a smaller amount of the liquid than an amount of the liquid droplets ejected from the first nozzle group. An aperture size of each nozzle constituting the second nozzle group is smaller than that of each nozzle constituting the first nozzle group.

### CROSS REFERENCES TO RELATED APPLICATIONS

The present invention contains subject matter related to Japanese Patent Application No. 2008-249907 filed in the Japanese Patent Office on Sep. 29, 2008, the entire contents of which are incorporated herein by reference.

### BACKGROUND

1. Technical Field

The present invention relates to a liquid ejecting apparatus.

2. Related Art

The liquid ejecting apparatus is an apparatus which includes a liquid ejecting head capable of ejecting liquid and ejects various liquids from the liquid ejecting head. Representative examples of the liquid ejecting apparatus include image recording apparatuses such as an ink jet type printer (hereinafter, referred to as a printer) which performs printing by ejecting (spraying) or landing ink in a liquid state on a printing paper and the like as a landing target. Recently, liquid ejecting apparatuses have not been limited to image recording apparatuses, but have been applied to various fabrication apparatuses. For example, in apparatuses for fabricating displays such as liquid crystal displays, plasma displays, organic EL (Electro Luminescence) displays, or FED (surface emission displays), the liquid ejecting apparatuses are used to eject various liquid materials such as color materials or electrodes onto a pixel formation region or a electrode formation region.

Some of the above mentioned printers perform “band printing” as a recording printing method focused on a printing speed (for example, refer to JP-A-2003-246054). In “band printing”, for example, the following printing operation based on a band unit is repeated: a bundle (the band B shown in FIG. 7) of main scanning lines (raster lines), of which the quantity corresponds to a plurality of nozzles arranged in a sub-scanning direction (a nozzle array direction) of the printing paper, that is, the quantity is equal to the number of nozzles ejecting ink simultaneously, is printed by ejecting the ink from all the nozzles constituting the nozzle array so as to sequentially form dots on the printing paper while relatively moving a printing medium (a landing target) such as a printing paper and an ink jet type printing head (hereinafter, a printing head) in the main scanning direction; subsequently the printing head and the printing paper are relatively moved in the sub-scanning direction by the amount of the printed main scanning lines; and the next band is printed. In this band printing, although the number of the scanning operations of the printing head in the main scanning direction is small, it is possible to increase the printing speed.

However, in such band printing, the total amount of ink which is ejected at once onto the printing paper becomes larger than that of the ink in the case where an image is formed by minutely repeating the main scanning and sub-scanning operations. Hence, when an image having a dark color is formed on the printing paper such as a normal paper (at the time of high duty), the ink tends to run. The running becomes conspicuous in the end portions of the band which is dry since the ink does not land in the vicinity thereof. Hence, as indicated by the arrows of FIG. 7, the ink tends to run in the boundary portions of the band B, and thus there is concern about occurrence of black stripes at the seams between the bands when the running portion overlaps with the ink of the next band.

In order to suppress the occurrence of the black stripes, the relative displacement of the printing head and the printing paper in the sub-scanning can be changed (adjusted to separate the adjacent bands). In such a way, it is possible to prevent the black stripes from occurring, but when an image having a light color is formed (at the time of low duty), the total amount of the ink ejected at once onto the printing paper becomes smaller. Hence, the intervals between the main scanning lines excessively increase, and thus there is concern about occurrence of white stripes. For this reason, it is necessary to adjust the displacement of the sub-scanning for each image, and thus the control thereof is therefore complex.

### SUMMARY

An advantage of some aspects of the invention is to suppress the running of the liquid in the band boundary portions.

The invention has been made to solve at least a part of the problem mentioned above, and can be realized as the following form or application example.

According to an aspect of the invention proposed in order to achieve the advantage, a liquid ejecting apparatus includes: a liquid ejecting head that ejects liquid from nozzles; a first nozzle group that is formed of nozzles for ejecting the liquid; and a second nozzle group that is disposed on both sides of the first nozzle group in a nozzle arrangement direction, and is formed of nozzles for ejecting liquid droplets having the same characteristics as liquid droplets of the first nozzle group and ejecting a smaller amount of the liquid than an amount of the liquid droplets ejected from the first nozzle group. An aperture size of each nozzle constituting the second nozzle group is smaller than that of each nozzle constituting the first nozzle group.

The other characteristics and advantages of the other aspects of the invention will be clarified in the following description with reference to the accompanying drawings.

### BRIEF DESCRIPTION OF THE DRAWINGS

The invention will be described with reference to the accompanying drawings, wherein like numbers reference like elements.

FIG. 1 is a perspective view illustrating a configuration of a printer.

FIG. 2 is a principal part sectional view illustrating a configuration of a printing head.

FIG. 3 is a top plan view illustrating a configuration of a nozzle plate.

FIG. 4 is a block diagram illustrating an electrical configuration of the printer.

FIG. 5 is a schematic diagram illustrating a correspondence relationship of aperture diameters (ejection amounts) of the nozzles.

FIG. 6 is a schematic diagram illustrating a band printing.

FIG. 7 is a schematic diagram illustrating a known band printing.

### DESCRIPTION OF EXEMPLARY EMBODIMENTS

The description and the accompanying drawings clarify at least the following. The invention has been proposed in order to achieve the advantage. Thus, a liquid ejecting apparatus includes: a liquid ejecting head that ejects liquid from nozzles; a first nozzle group that is formed of nozzles for ejecting the liquid; and a second nozzle group that is disposed on both sides of the first nozzle group in a nozzle arrangement direction, and is formed of nozzles for ejecting liquid droplets having the same characteristics as liquid droplets of the first nozzle group and ejecting a smaller amount of the liquid than an amount of the liquid droplets ejected from the first nozzle group. The aperture size of each nozzle constituting the second nozzle group is smaller than that of each nozzle constituting the first nozzle group.

With such a configuration, the amount of the liquid ejected from the nozzles constituting the second nozzle group is smaller than that of the liquid ejected from the nozzles constituting the first nozzle group. Hence, the liquid density per unit area (landing area) of the end portions of a band in a sub-scanning direction becomes thinner than that of the central portion of the band. Here, the band includes a plurality of main scanning lines arranged in the sub-scanning direction (a nozzle group direction) intersecting with a main scanning direction, and is formed in a way that dots are sequentially formed on a landing target by ejecting the liquid from the nozzles while making the liquid ejecting head and the landing target perform the main scanning relative to each other in a direction intersecting with the nozzle groups. As a result, it is possible to suppress running of the liquid in both the end portions of the band in the sub-scanning direction.

In the above-mentioned configuration, it is preferred that the amount of the liquid ejected from the nozzle constituting the second nozzle group has a tendency to become smaller as the position of the nozzle moves closer to the end portions of the nozzle group.

The “tendency to become smaller” means that in the overall view of the nozzles constituting the second nozzle group, the ejection amount may be set to become smaller from the nozzle located on the first nozzle group side (the central portion side) toward the nozzle located on the end portion sides, and some of the nozzles may have the same ejection amount or reversed magnitudes (amounts).

With such a configuration, since the amount of the liquid ejected from the nozzle constituting the second nozzle group has a tendency to become smaller as the position of the nozzle moves closer to the end portions of the nozzle group, the liquid density per unit area (landing area) gradually becomes thinner as it gets closer to the end portions of the band in the sub-scanning direction. As a result, it is possible to more efficiently suppress the running of the liquid in both the end portions of the band in the sub-scanning direction.

In the above-mentioned configuration, it is preferred that the aperture size of the nozzle constituting the second nozzle group has a tendency to become smaller as the position of the nozzle moves closer to the end portions than the first nozzle group.

Further, in the above-mentioned configuration, it is preferred that the second nozzle group be formed of one partial second nozzle group which is disposed on one side of the first nozzle group in the nozzle arrangement direction and the other partial second nozzle group which is disposed on the other side of the first nozzle group in the nozzle arrangement direction. In addition, it is also preferred that the nozzles of the one partial second nozzle group correspond one-to-one with the nozzles of the other partial second nozzle group. In addition, it is also preferred that the total amount of the liquid ejected from both each nozzle of the one partial second nozzle group and each corresponding nozzle of the other partial second nozzle group be adjusted to the amount of the liquid droplets ejected from the single nozzle of the first nozzle group.

Here, the meaning of “adjusted” includes a case of perfect congruity with a defined amount and a case where an error occurs relative to the defined amount.

The meaning of “ejected toward landing area” includes a case where the landing positions of the liquid ejected from both the nozzles coincide with each other and a case where the landing positions of the liquid ejected from both the nozzles are slightly deviated from each other.

With such a configuration, by ejecting the liquid from the nozzles of the one partial second nozzle group and the nozzles of the other partial second nozzle group corresponding to each other toward the same second landing area, a defined amount of liquid lands on the second landing area. Therefore, it is possible to suppress the running of the liquid while suppressing change in the density thereof. As a result, it is possible to prevent black stripes from occurring in the boundary portions between the bands.

In addition, in the above-mentioned configuration, it is preferred that a moving section be further provided which relatively moves at least one of the nozzle groups and a landing target in the nozzle arrangement direction. In addition, it is also preferred that the moving section relatively move at least one of the nozzle groups and the landing target so that the liquid ejected from the nozzle of the other partial second nozzle group corresponding to the nozzle of the one partial second nozzle group lands on the same position as a landing position of the liquid ejected from the nozzle of the one partial second nozzle group in a predetermined direction.

The preferred embodiments of the invention will be described below with reference to the drawings. Furthermore, the embodiments to be described below will be described as examples of the invention, and it may be that not all the components in the following description are absolutely essential for the invention.

### PREFERRED EMBODIMENTS

Hereinafter, embodiments of the invention will be described with reference to the accompanying drawings.

### First Embodiment

Hereinafter, preferred embodiments for carrying out the invention will be described with reference to the accompanying drawings. Furthermore, various limitations are applied to the flowing embodiments as preferred detailed examples of the invention, but the scope of the invention is not limited to these embodiments if there is no particular description limiting the invention. Further, in the following section, an ink jet type recording apparatus (hereinafter, referred to as a printer) will be exemplified as the liquid ejecting apparatus according to the aspect of the invention.

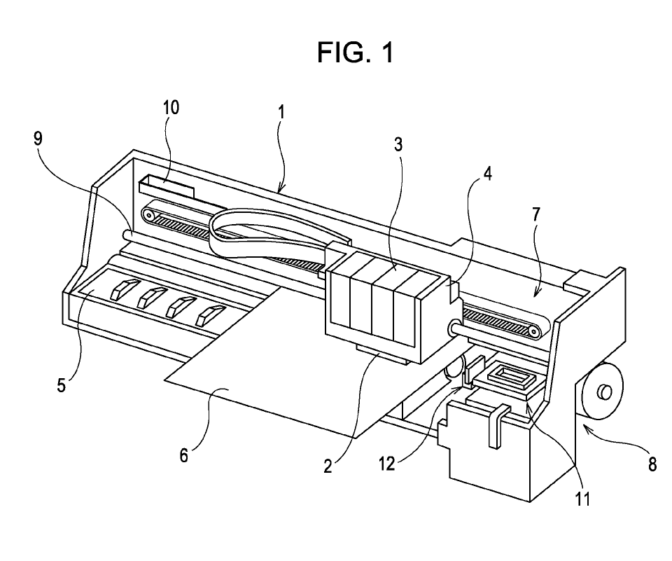

FIG. 1 is a perspective view illustrating a configuration of a printer 1. The printer 1 generally includes: a carriage 4 which has a printing head 2 as the liquid ejecting head mounted thereon and an ink cartridge 3 detachably mounted thereon; a platen 5 which is disposed below the printing head 2; a carriage moving mechanism 7 which reciprocates the carriage 4 (the printing head 2) in a widthwise direction of a printing paper 6 as the landing target, that is, a main scanning direction; and a paper feeding mechanism 8 (as the moving section) which feeds the printing paper 6 in a sub-scanning direction (a nozzle array direction to be described later), that is, a direction intersecting with the main scanning direction. Furthermore, it may be possible to adopt the configuration in which the ink is supplied to the printing head 2 through an ink supply tube by mounting the ink cartridge 3 on the casing side of the printer 1.

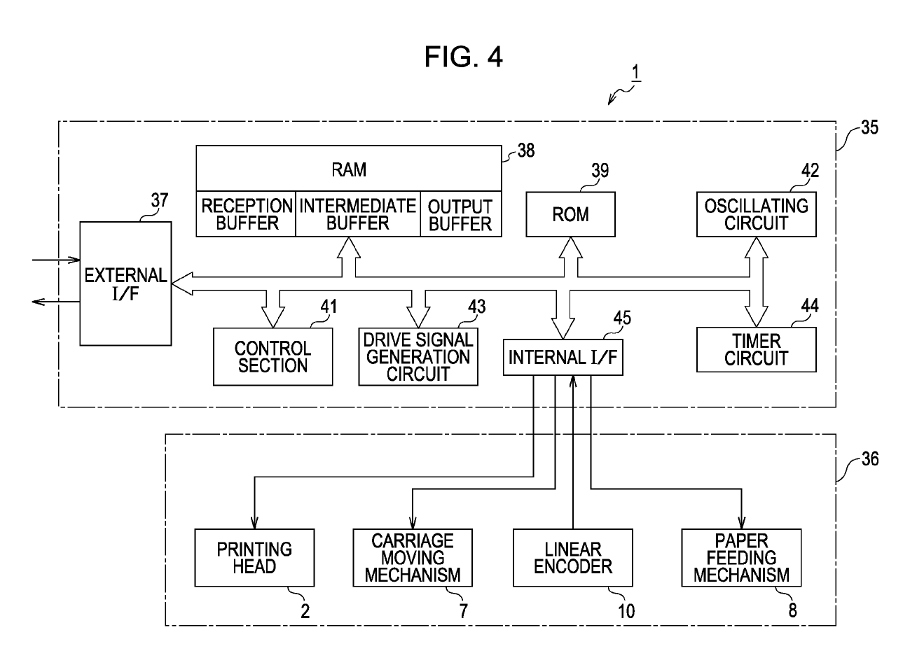

The carriage 4 is pivotally supported by a guide rod 9 extending in the main scanning direction, and the carriage 4 is configured to move in the main-scanning direction along the guide rod 9 by an operation of the carriage moving mechanism 7. The position of the carriage 4 in the main scanning direction is detected by a linear encoder 10. The detected signal, that is, an encoder pulse is transmitted to a control section 41 (refer to FIG. 4) of a printer controller. In such a manner, the control section 41 is able to control a printing operation (the ejecting operation) or the like of the recording head 2 while recognizing a scanning position of the carriage 4 (the printing head 2) on the basis of the encoder pulse from the linear encoder 10.

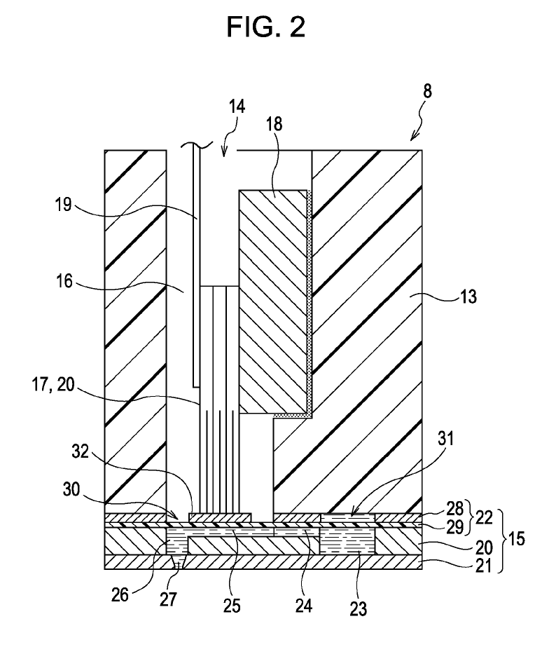

A home position, which is a scanning start point, is set on the end portion region on the outside (the right side in FIG. 1) of the printing region within a movable range of the carriage 4. At the home position according to the embodiment, a capping member 11 for sealing a nozzle formation surface (a nozzle plate 21 in FIG. 2) of the printing head 2 and a wiper member 12 for wiping out the nozzle formation surface of the printing head 2 are disposed. The printer 1 is configured to enable so-called two-way printing. The two-way printing is able to print characters, images, and the like on the printing paper 6 in two-way directions of a forward movement during which the carriage 4 (printing head 2) moves from the home position toward the end portion on the side opposite thereto and a backward movement during which the carriage 4 returns to the home position from the end portion on the side opposite thereto.

FIG. 2 is a principal part sectional view illustrating a configuration of the printing head 2. The printing head 2 includes a casing 13, an oscillator unit 14 which is housed in the casing 13, and a flow passage unit 15 which is bonded to a bottom surface (a tip end surface) of the casing 13. The casing 13 is, for example, made of epoxy based resin. The casing 13 has therein a housing hollow portion 16 for housing the oscillator unit 14. The oscillator unit 14 includes piezoelectric elements 17 which function as a pressure generating section, a fixing plate 18 to which the piezoelectric elements 17 are bonded, and a flexible cable 19 which is for supplying driving signals and the like to the piezoelectric elements 17. The piezoelectric elements 17 are formed as a laminated type by dividing a piezoelectric plate, in which piezoelectric body layers and electrode layers are alternatively laminated, in a pectinate shape, and are vertically oscillating mode piezoelectric elements which are able to expand and contract in a direction orthogonal to a laminated direction.

The flow passage unit 15 is configured by bonding the nozzle plate 21 on one surface of the substrate of the flow passage formation substrate 20 and the oscillating plate 22 on the other surface of the flow passage formation substrate 20. The flow passage unit 15 is provided therein with a reservoir 23, an ink supply port 24, a pressure generating chamber 25, a nozzle communication port 26, and a nozzle 27. A serial ink flow passage is formed corresponding to each nozzle 27. The ink flow passage extends from the ink supply port 24 through the pressure generating chamber 25 and the nozzle communication port 26 to the nozzle 27.

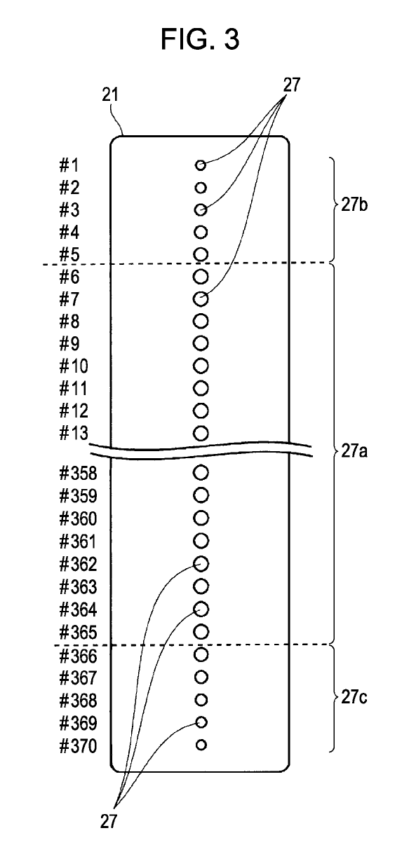

FIG. 3 is a top plan view illustrating a configuration of a nozzle plate 21. Furthermore, the nozzles 27 are referenced by serial numbers (Nos. 1 to 370) to distinguish them. In the nozzle plate 21 according to the present example, a single nozzle array (as the nozzle group) is formed of the 370 nozzles 27 which eject an ink (as the liquid according to the embodiment of the invention) and are arranged in parallel with a transport direction T of the printing paper 2, and a plurality of the nozzle arrays are arranged in a direction orthogonal to the transport direction T of the printing paper 2. Ink droplets ejected from a single nozzle array have the same color. That is, the liquid ejected from a single array is configured to have the same characteristics. In the nozzle array according to the embodiment, the nozzles 27 are arranged at a formation pitch of, for example, 360 dpi. The nozzle array includes a first nozzle group 27a which is located on the central portion thereof and formed of the plurality of nozzles 27 for ejecting the same amount of the ink, and the second nozzle groups 27b and 27c which are disposed on both the sides of the first nozzle group 27a in the nozzle arrangement direction and are formed of the nozzles 27 for ejecting an amount of ink smaller than the amount of the ink droplets ejected from the first nozzle group. The second nozzle groups are formed of one partial second nozzle group 27b (nozzles Nos. 1 to 5) disposed on one side (the upper side in FIG. 3) of the first nozzle group 27a in the nozzle arrangement direction, and the other partial second nozzle group 27c (nozzles Nos. 366 to 370) on the other side of the first nozzle group 27a in the nozzle arrangement direction.

The second nozzle groups 27b and 27c are nozzle groups formed of the nozzles 27 for ejecting the ink onto the end portion regions of the band in the band printing (to be described later). In the embodiment, the aperture size (an inner diameter) of each nozzle 27 constituting the second nozzle groups 27b and 27c is set to become smaller than that of each nozzle 27 constituting the first nozzle group 27a. In addition, the aperture size of each nozzle 27 of the second nozzle groups 27b and 27c is set to become smaller as the position of the nozzle 27 moves closer to the end portions (the side opposite to the first nozzle group 27a in the nozzle arrangement direction) than the first nozzle group 27a. That is, in each second nozzle group, the inner diameter of the nozzle 27 becomes smaller in a stepwise fashion from the first nozzle group 27a side (the central portion side) toward the end portion side. Accordingly, in the one partial second nozzle group 27b, the inner diameter of the nozzle No. 5 is largest (but is smaller than the inner diameter of the nozzle 27 of the first nozzle group 27a), the inner diameter of the nozzle 27 gradually becomes smaller as it gets closer to the nozzle No. 1, and an inner diameter of the nozzle No. 1 is smallest. Likewise, in the other partial second nozzle group 27c, the inner diameter of the nozzle No. 366 is largest, the inner diameter of the nozzle 27 gradually becomes smaller as it gets closer to the nozzle No. 370 on the end portion side, and the inner diameter of the nozzle No. 370 is smallest. With such a configuration, when drive pulses having the same waveform are applied to the piezoelectric elements 17, the amount of the ink ejected from the nozzles 27 constituting the second nozzle groups 27b and 27c is set to become smaller than that of the nozzles 27 of the first nozzle group 27a. More specifically, the amount of the ink of the nozzle 27 is set to become smaller as the position of the nozzle 27 moves closer to the end portions thereof than the first nozzle group 27a.

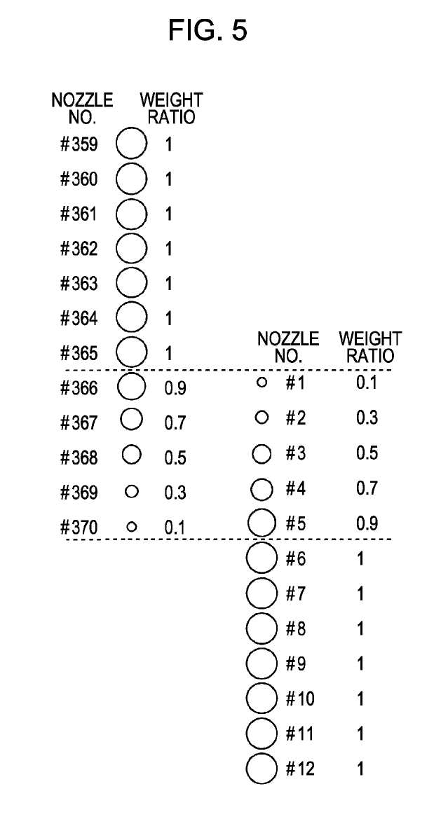

Further, the nozzles 27 of the one partial second nozzle group 27b and the nozzles 27 of the other partial second nozzle group 27c correspond one-to-one with each other sequentially from the nozzles 27 (the nozzle No. 1 and the nozzle No. 366) on the one side (on the upper side of FIG. 3) thereof to the nozzles 27 (the nozzle No. 5 and the nozzle No. 370) on the other side thereof in the nozzle arrangement direction. Specifically, in the example of the embodiment, the nozzle No. 1 of the one partial second nozzle group 27b pairs with the nozzle No. 366 of the other partial second nozzle group 27c, similarly the nozzle No. 2 pairs with the nozzle No. 367, the nozzle No. 3 pairs with the nozzle No. 368, the nozzle No. 4 pairs with the nozzle No. 369, and the nozzle No. 5 pairs with the nozzle No. 370. The nozzles 27 of the one partial second nozzle group 27b of the order from the nozzle 27 farther from the first nozzle group to the nozzle 27 closer thereto sequentially correspond to the nozzles 27 of the other partial second nozzle group 27c of the order from the nozzle 27 closer to the first nozzle group to the nozzle 27 farther therefrom. As shown in FIG. 5, between the pairs of the nozzles 27, the total amount of the ink ejected at once from both thereof is adjusted to the amount (a defined amount) of the ink ejected at once from the nozzle 27 of the first nozzle group 27a. For example, it may be assumed that a defined amount in a weight ratio of the ink ejected from each nozzle 27 is set to 1. In this case, if the weight ratio of the ink ejected from the nozzle No. 1 is 0.1, the weight ratio of the ink ejected from the nozzle No. 366 corresponding to this is 0.9. As a result, the total weight ratio combined is equal to 1.

Here, the number of the nozzles 27 constituting the first nozzle group 27a and the second nozzle groups 27b and 27c is not limited to the example. Further, it is not always necessary to adopt the configuration in which the aperture sizes or the ejection ink amounts of the nozzles of the second nozzle groups sequentially become smaller toward the end portion. For example, the inner diameter (or an ejection amount of the ink) of the nozzle 27 of No. 2 may be equal to the inner diameter (or an ejection amount of the ink) of the nozzle 27 of No. 3, and the inner diameter (or an ejection amount of the ink) of the nozzle 27 of No. 4 may be equal to the inner diameter (or an ejection amount of the ink) of the nozzle 27 of No. 5. In this manner, the change thereof may be stepwise for each set of nozzles. Further, it may be possible to adopt a configuration in which the inner diameter (or an ejection amount of the ink) of the nozzle 27 of No. 2 may be larger (more) than the inner diameter (or an ejection amount of the ink) of the nozzle 27 of No. 3. The bottom line is, in the overall view of the nozzles 27 constituting the second nozzle group, the inner diameter (or the ejection amount of the ink) of the nozzle preferably has a tendency to become smaller from the central portion side toward the end portion sides, and some of the nozzles 27 may have reversed magnitudes. Furthermore, the band printing using the nozzle groups will be described later in detail.

The oscillating plate 22 has a double layer structure in which an elastic film 29 is laminated on a surface of a supporting plate 28. In the embodiment, the oscillating plate 22 is made of a composite plate formed in a way that the supporting plate 28 is made of stainless steel plate as a metal plate and the elastic film 29 made of resin film is laminated on the surface of the supporting plate 28. The oscillating plate 22 is provided with a diaphragm portion 30 for changing the volume of a pressure generating chamber 25. Further, the oscillating plate 22 is provided with a compliance portion 31 for sealing a part of the reservoir 23.

The diaphragm portion 30 is formed by partially removing the supporting plate 28 in the etching process and the like. Specifically, the diaphragm portion 30 includes island portions 32 to which the tip end surfaces of the piezoelectric elements 17 are bonded and an elastic thin film portion which is formed by removing the parts of the supporting plate 28 around the island portions 32. The compliance portion 31 is formed by removing an area of the supporting plate 28 facing an opening surface of the reservoir 23 in the etching process and the like in the same manner as the diaphragm portion 30, and functions as a damper for absorbing fluctuation in the pressure of the liquid stored in the reservoir 23.

In addition, since the tip end surfaces of the piezoelectric elements 17 are bonded to the island portions 32, the volume of the pressure generating chamber 25 can be changed by expanding and contracting free end portions of the piezoelectric elements 17. This change in volume causes a change in ink pressure within the pressure generating chamber 25. The printing head 2 is configured to eject the ink from the nozzles 27 by using the pressure change.

FIG. 4 is a block diagram illustrating an electrical configuration of the printer 1. The printer 1 generally includes a printer controller 35 and a print engine 36. The printer controller 35 includes: an external interface (an external I/F) 37 which receives print data and the like input from an external apparatus such as a host computer; a RAM 38 which stores various data and the like; a ROM 39 which stores a control routine for various data processes; a control section 41 (as a controller) which controls the components; an oscillating circuit 42 which generates a clock signal; a driving signal generation circuit 43 which generates a driving signal to be supplied to the printing head 2; a timer circuit 44 which functions as a timer; and an internal interface (an internal I/F) 45 which inputs and outputs signals to and from the print engine 36. Further, the print engine 36 includes the printing head 2, the carriage moving mechanism 7, the linear encoder 10, and the paper feeding mechanism 8.

The control section 41 performs various control operations, and converts the print data input from the external apparatus through the external I/F 37 into dot pattern data corresponding to a dot pattern. Subsequently, when the dot pattern data corresponding to one row which can be printed by one main scanning of the printing head 2 is obtained, the control section 41 outputs the dot pattern data corresponding to one row to the printing head 2 through the internal I/F 45. The driving signal generation circuit 43 repeatedly generates the driving signal COM including a plurality of drive pulses for each unit period. The driving signal COM, which is generated by the driving signal generation circuit 43, is formed of, for example, three drive pulses. The three drive purses are as follows: a small dot drive pulse for ejecting an amount of the ink (a small dot ink droplet) required to form a small dot; a medium dot drive pulse for ejecting an amount of the ink (a medium dot ink droplet) required to form a medium dot; and a large dot drive pulse for ejecting an amount of the ink (a large dot ink droplet) required to form a large dot. Any one of these drive pulses is selected and supplied to the piezoelectric element 17, and then the defined amount of the ink corresponding to the selected drive pulse is ejected from the nozzle 27. Furthermore, as described above, an amount of the ink smaller than the defined amount is ejected from the nozzles 27 belonging to the second nozzle groups 27b and 27c.

Next, the band printing of the printer 1 configured as described above will be described. In the band printing, a plurality of the main scanning lines (the raster lines), each of which is formed of a plurality of dots arranged in the main scanning direction, are formed in the sub-scanning direction, thereby printing a band on the printing paper 6, and thus images and the like can be printed with these band units. Furthermore, in the band printing, a dot formation interval in the sub-scanning direction coincides with the formation pitch (360 dpi in the embodiment) of the nozzles 27 in the nozzle array. The band printing includes a method in which the band is printed by performing the main scanning once and a method in which the dot formation interval in the sub-scanning direction is smaller than the formation pitch of the nozzles 27 and the band is printed by performing the main scanning a plurality of times while performing the sub-scanning (a minute feeding) of the printing head 2 and the printing paper 6.

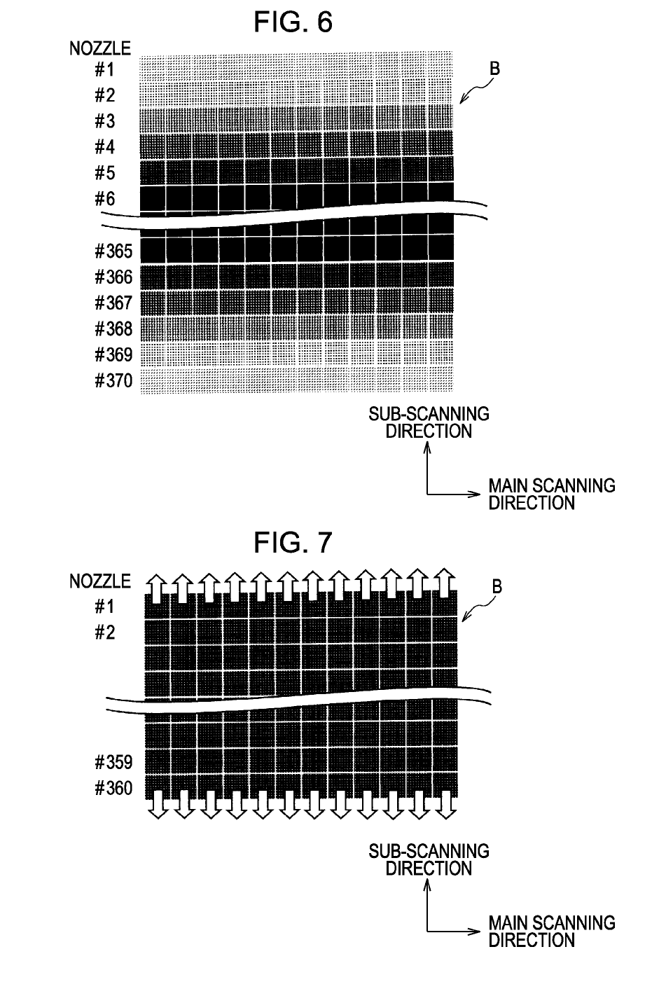

FIG. 6 shows an example in which one band B is printed by one main scanning using all the nozzles 27 Nos. 1 to 370. In the drawing, the respective main scanning lines are referenced by the numbers (Nos. 1 to 370) of the nozzles 27 printing the corresponding main scanning lines. Further, each landing area (pixel), in which the ink lands and a dot is formed, is schematically represented by a rectangular frame, and the magnitude of the amount of the ink landing on each landing area is represented by a density of the hatching. In the embodiment, for example, dots are formed in a way that the ink is ejected onto the printing paper 6 from the nozzles 27 by applying the large dot drive pulses to the piezoelectric element 17 corresponding to all the nozzles 27 and the ink lands on the landing areas, and the plurality of dots are arranged in the main scanning direction, thereby forming the main scanning line for each nozzle 27. Then, the 370 main scanning lines successively arranged in the sub-scanning direction constitute one band B.

Here, as described above, from each of the total 360 nozzles 27 Nos. 6 to 365 constituting the first nozzle group 27a, the defined amount of the ink corresponding to the large dot is ejected, and the ink lands on a landing area (the first landing area) of the printing paper 6, thereby forming a large dot. In contrast, from each of the nozzles Nos. 1 to 6 and 366 to 370 constituting the second nozzle group 27b and 27c, an amount of the ink smaller than the defined amount is ejected, and the ink lands on a landing area (the second landing area) different from the first landing area of the printing paper 6, thereby forming a dot smaller than the large dot. With such a configuration, the density of the ink per unit area (landing area) becomes thinner in both end portions (the boundary portions of the band B) of the band B in the sub-scanning direction as compared with the central portion of the band B. Hence, it is possible to suppress the running of the ink in both end portions of the band B in the sub-scanning direction. In addition, as described above, the amount of the ink ejected from each nozzle 27 constituting the second nozzle groups 27b and 27c is smaller as the position of the nozzle 27 is closer to the end portions thereof than the first nozzle group 27a. Hence, as shown in the drawing, the density of the ink becomes thinner as it gets closer to both end portions of the band B in the sub-scanning direction. Therefore, it is possible to more effectively suppress the running of the ink in both end portions of the band B in the sub-scanning direction. Furthermore, when the band B is a leading band in the sub-scanning direction on the printing paper 6, it may be possible to adopt a configuration in which the nozzles 27 Nos. 1 to 5 are not used.

When the one band B is printed, the paper feeding mechanism 8, which functions as a moving section, moves the printing paper 6 relative to the printing head 2 (or moves the printing head 2 relative to the printing paper 6) in the sub-scanning direction only by the number of the main scanning lines of the printed band B, and the next band is printed. At this time, in the example of FIG. 6, the sub scanning operations are performed by 365 lines, of which the number is obtained by subtracting the number (which is 5 in the embodiment) of the nozzles 27 of the one-sided partial second nozzle group from the total number (which is 370 in the embodiment) of the nozzles 27, and then the next band is printed below the band B. Specifically, the next band is printed so that the main scanning lines Nos. 1 to 5 (the main scanning lines printed by the nozzles 27 of the one partial second nozzle group 27b) of the next band overlaps with the main scanning lines Nos. 366 to 370 (the main scanning lines printed by the nozzles 27 of the other partial second nozzle group 27c) of the printed band B. With such a configuration, as shown in FIG. 5, in the boundary portions in which the adjacent bands overlap with each other, the ink is ejected toward the same second landing area from the nozzle 27 of the one partial second nozzle group 27b and the nozzle 27 of the other partial second nozzle group 27c corresponding to each other. The paired nozzles 27 eject the ink so as to form the same type of dot (the large dot, the medium dot, the small dot, and the like) at the same position. Since the total amount of the ink ejected from both of those is adjusted to the defined amount which is the ink ejection amount of the first nozzle group 27a, each dot is formed on the second landing area by landing the defined amount of the ink thereon. Accordingly, it is possible to suppress soaking of the ink while suppressing the change in final density of the ink (change in hue of the ink when the inks having different colors land) in the boundary portions between bands adjacent to each other in the sub-scanning direction. As a result, it is possible to prevent the black stripe from occurring in the boundary portions between the bands.

Further, since it is possible to prevent black stripes from occurring without changing the relative displacement (a sub-scanning adjustment amount) between the printing paper 6 and the printing head 2 in the sub-scanning, it is not necessary to adjust the displacement of the sub-scanning for each printing mode.

Furthermore, when some of the nozzles 27 of the other partial second nozzle group 27c are not used in the process of the printing of the band B, some of the nozzles 27 of the one partial second nozzle group 27b corresponding thereto are also not used.

However, the invention is not limited to the embodiment mentioned above, and may be modified in various forms on the basis of the description according to the aspects of the invention.

For example, the nozzle array may not be parallel with the sub-scanning direction (the transport direction), but may be inclined from the sub-scanning direction at a degree at which the nozzle array is not orthogonal to the sub-scanning direction.

The embodiment shows the example configured as follows: the aperture size of each nozzle 27 constituting the second nozzle groups 27b and 27c is set to become smaller as the position of the nozzle 27 moves closer to the end portions than the first nozzle group 27a, and thus the amount of the ink ejected from each nozzle 27 constituting the second nozzle groups 27b and 27c is set to become smaller as the position of the nozzle 27 moves closer to the end portions thereof than the first nozzle group 27a. However, the invention is not limited to this. For example, the amount of the ink may be adjusted by changing the waveform of the drive pulse applied to the piezoelectric element 17 corresponding to the nozzle 27 constituting the second nozzle groups 27b and 27c. As a result, the bottom line is that it is possible to adopt an optional configuration when the amount of the ejected ink is smaller as the ejected position of the nozzle 27 is closer to the end portions than thereof the first nozzle group 27a.

The total amount of the liquid ejected from the corresponding nozzles of the second nozzle group may be set to be larger than the defined amount in consideration of dryness in the process of the printing. The dot formed by the nozzle of the first nozzle group may in the end be the same as the dot formed by ejecting the ink twice from the nozzle of the second nozzle group on the print medium.

The aspects of invention may be applied to liquid ejecting apparatuses other than the printer as long as the configuration, in which the liquid lands on the landing target while relatively moving the liquid ejecting head and the landing target, is adopted. For example, the aspects of the invention may be applied to display manufacturing apparatuses, electrode manufacturing apparatuses, chip manufacturing apparatuses, and the like.

What is claimed is:

1. A liquid ejecting apparatus comprising:
a liquid ejecting head that ejects liquid from nozzles;
a first nozzle group that is formed of nozzles for ejecting the liquid; and
a second nozzle group that is disposed on both sides of the first nozzle group in a nozzle arrangement direction, and is formed of nozzles for ejecting liquid droplets having the same characteristics as liquid droplets of the first nozzle group and ejecting a smaller amount of the liquid than an amount of the liquid droplets ejected from the first nozzle group,
wherein an aperture size of each nozzle constituting the second nozzle group is smaller than that of each nozzle constituting the first nozzle group.

2. The liquid ejecting apparatus according to claim 1, wherein an amount of the liquid ejected from the nozzle constituting the second nozzle group has a tendency to become smaller as a position of the nozzle moves closer to the end portions of the nozzle group.

3. The liquid ejecting apparatus according to claim 2, wherein the aperture size of the nozzle constituting the second nozzle group has a tendency to become smaller as the position of the nozzle moves closer to the end portions than the first nozzle group.

4. The liquid ejecting apparatus according to claim 3,
wherein the second nozzle group is formed of one partial second nozzle group which is disposed on one side of the first nozzle group in the nozzle arrangement direction and the other partial second nozzle group which is disposed on the other side of the first nozzle group in the nozzle arrangement direction,
wherein the nozzles of the one partial second nozzle group correspond one-to-one with the nozzles of the other partial second nozzle group, and
wherein the total amount of the liquid ejected from both each nozzle of the one partial second nozzle group and each corresponding nozzle of the other partial second nozzle group is adjusted to an amount of the liquid droplets ejected from the single nozzle of the first nozzle group.

5. The liquid ejecting apparatus according to claim 4, further comprising
a moving section that relatively moves at least one of the nozzle groups and a landing target in the nozzle arrangement direction,
wherein the moving section relatively moves at least one of the nozzle groups and the landing target so that the liquid ejected from the nozzle of the other partial second nozzle group corresponding to the nozzle of the one partial second nozzle group lands on the same position as a landing position of the liquid ejected from the nozzle of the one partial second nozzle group in a predetermined direction.
